(19) United States
(12) Patent Application Publication
(10) Pub. No.: US 2005/0019490 A1
(43) Pub. Date: Jan. 27, 2005

(54) Method for the production of bearing materials, bearing materials produced by said methods and use of said bearing materials

(76) Inventors: Achim Adam, Nauheim (DE); Stefan Fuchsberger, Eltville (DE); Joachim Schluter, Wiesbaden (DE)

Correspondence Address: Robert L Stearns;Howard and Howard Attorneys, 39400 Woodward Avenue, Bloomfield Hills, MI, 48304, US

(21) Appl. No.: 10/490,923

(22) PCT Filed: Sep. 24, 2002
(86) PCT No.: PCT/DE02/03608

(30) Foreign Application Priority Data
Sep. 26, 2001 (DE) 10147303.6

(51) Int. Cl. B05D 5/00

(52) U.S. Cl. 427/247

(57) ABSTRACT

A method for the production of bearing materials is disclosed, in which a strip of a metallic woven support is continuously provided with a slip layer mostly comprising polytetrafluoroethylene (PTFE), covering one side thereof. The woven support is coated on one side with a paste of the material for the slip layer, whereby the woven support runs with the lower surface thereof in full-surface contact with a roller during and directly after the coating.

The present invention relates to a method of producing bearing materials having the features of the precharacterizing clause of claim 1, bearing materials produced using this method and use of these bearing materials.

In order to produce materials for composite bearings provided with a plastics overlay, it is known to provide a plastics overlay on a solid, especially strip-form backing framework, preferably of steel, a copper and/or an aluminum alloy, wherein this plastics overlay comprises as base material polytetrafluoroethylene (PTFE), to which further additions are optionally added, for example further polymers or wear- and/or friction-reducing additions. An overlay dispersion or paste is applied uniformly to this solid metallic backing framework, which in DE 11 32 710 AS is also known as a porous metal strip, with the assistance of a roll pair arranged downstream, such that the solid backing framework coated in this way may then be subjected to heat treatment.

It is also known to use a metallic backing fabric instead of the backing framework described above, which fabric is provided with an overlay covering one side of the backing fabric and containing mainly polytetrafluoroethylene. In order to produce this known backing fabric, a method is used in which a web of the metallic backing fabric is provided continuously with a film applied to one side of the backing fabric, which film contains the overlay material. In the known method, the backing fabric covered in this way with the film is then guided through an appropriate press, such that the film is pressed into the fabric structure of the backing fabric on one side.

The known method described above has the disadvantage, however, that the films of overlay material required therefor can only be produced with a relatively large amount of effort, such that the bearing materials produced by this method have a relatively high production price.

The object of the present invention is to provide a method of producing bearing materials of the type indicated, with which a metallic backing fabric may be provided particularly simply and continuously with an appropriate overlay.

This object is achieved according to the invention by a method having the characterizing features of claim 1.

As with the above-mentioned prior art, the method according to the invention for producing bearing materials likewise provides for a web of a metallic backing fabric to be provided continuously with an overlay covering the backing fabric on one side and mainly containing polytetrafluoroethylene (PTFE), wherein, in contrast to the above-stated prior art, the backing fabric is not coated on its top face with a film but instead with a paste of the overlay material. In the method according to the invention, the bottom face of the backing fabric is guided during and immediately after coating in all-over contact with a roll, in such a way that, prior to coating, the overlay material paste is applied to the top face of the backing fabric, while the opposing face of the backing fabric, also abbreviated to bottom face in the present application, is guided during and immediately after this coating process in all-over contact with a roll, such that, in this processing state, the bottom face of the backing fabric thus lies on the surface of the roll. Preferably, the underside (bottom face) of the backing fabric is also in all-over contact with the roll immediately prior to the coating process.

The method according to the invention exhibits a number of advantages. For instance, it should first of all be noted that the method according to the invention, in contrast to the above-described known method in which a film containing the overlay material is applied to the metallic backing fabric, allows substantially more reasonably priced production of bearing materials, especially since the method according to the invention is a single-stage method and dispenses completely with the separate production of a film. Furthermore, the method according to the invention multiplies the range of possible overlay materials, since in the known method suitable films cannot be produced from all the possible overlay materials. Because with the method according to the invention the pasty overlay material is applied directly to the top face of the metallic backing fabric, not only may the composition of the overlay be varied without great effort but also the thickness thereof, which is likewise not possible in the above-mentioned prior art. It has surprisingly been noted that only the above-described one-sided all-over support of the bottom face of the backing fabric on the roll surface during and immediately after coating and preferably also additionally prior to coating effectively prevents pasty overlay material from accumulating undesirably on the bottom face of the backing fabric, as was always the case with direct coating of the backing fabric with the pasty overlay material, i.e. without the provision of corresponding support on a roll surface. It is therefore only by applying the method according to the invention that simple and problem-free production of a backing fabric properly provided with an overlay mainly on one side becomes possible.

In the context of the present description, the term backing fabric covers all structures which are especially distinguished in that openings are provided between the bottom face and the top face, through which the pasty material applied to the top face may penetrate through to the bottom face during coating.

The term coating denotes all application methods with which a predetermined and adjustable amount of pasty overlay material may be applied to the top face of the backing fabric, in particular pouring, spreading and/or spraying of the pasty material, in particular using appropriate coating knife or nozzle systems. Furthermore, this term coating also in particular covers application of the pasty overlay material by means of at least two rolls, wherein one roll, preferably an upper roll, applies the pasty overlay material to the top face of the backing fabric and there at the same time distributes it evenly over the top face and into the openings, while a second roll, preferably a lower roll, is in contact with the bottom face of the backing fabric.

A particularly suitable first embodiment of the method according to the invention is characterized in that the web of backing fabric is guided through the nip of a calender to coat the backing fabric with the pasty overlay material, wherein the calender comprises at least one upper roll and at least one lower roll.

The upper roll of the calender may exhibit a smaller diameter than the lower roll and/or the lower roll of the calender may be roughened. The diameter of the upper roll amounts preferably to <70% of the diameter of the lower roll.

This nip has the effect that, on the one hand, application of the pasty overlay material is rendered uniform and reproducible while, on the other hand, the amount of pasty material applied and the degree of penetration thereof into the fabric spaces may be varied by varying the linear pressure. The roughened surface of the lower roll lying underneath in all-over contact with the bottom face of the backing fabric ensures that no water is discharged at the underside of the backing fabric, which would result in non-uniform coverage of the top face or even the occurrence of areas completely devoid of coating. Since with the method according to the invention this water discharge is thus prevented, the desired one-sided, uniform coverage of the fabric structure by the pasty overlay material, i.e. the arrangement of this pasty material predominantly in and on the top face of the backing fabric, is achieved, such that the bottom face of the backing fabric, especially in the outer area thereof, accordingly does not exhibit any pasty overlay material.

The discharge of water is especially minimized when a roll is selected as lower roll whose surface facing the backing fabric, i.e. thus the surface which comes into contact with the bottom face of the backing fabric immediately prior to and during coating, is provided with particles and/or unevennesses of the order of between 5 μm and 50 μm, preferably with particles and/or unevennesses of the order of between 10 μm and 30 μm. This surface of the lower roll comprises the above-mentioned particles or unevennesses in a uniform distribution. By selecting such a lower roll, whose surface exhibits uniform defined roughness produced by the particles or unevennesses, it is possible to prevent particularly effectively and reproducibly the above-described discharge of liquid, especially water, during the coating process, with the consequence that, in the case of a backing fabric treated in this way, only the top face and at most also the spaces in the fabric is/are provided with the overlay material and that a particularly uniform, defect-free top face is obtained.

Unevennesses are understood to mean regular or irregular surface texturing which may be produced by appropriate mechanical or other treatment, for example by sandblasting or laser beam treatment. Rough surfaces may also be distinguished in that the surface of the lower roll is preferably provided with corresponding engraving, for instance especially with pearlescent engraving.

A particularly preferred further development of the method according to the invention is characterized in that the surface of the lower roll is provided with a wrapping, in order to produce the above-described roughness on the surface of this lower roll. In particular, a wrapping of paper, preferably of hydrophobized paper, plastics or textiles is selected therefor, wherein, through selection of the surface smoothness of the associated wrapping, the desired roughness of the surface of the lower roll may be set. This embodiment of the method according to the invention exhibits the additional advantage that the surface roughness of the lower roll may be varied very quickly, since it is merely necessary therefor to replace the associated wrapping. When using wrappings of paper or textile, care must be taken to ensure that the associated wrapping, which comes into contact with the bottom face of the backing fabric, is especially water-impermeable and/or hydrophobic, which may be achieved simply and without difficulty, for example by appropriate coatings or by selecting hydrophobic fibers.

A particularly advantageous further development of the above-described embodiment of the method according to the invention is characterized in that the lower roll is provided with a wrapping as mentioned above consisting of a film of biaxially oriented polyester or of biaxially oriented polycarbonate, wherein such a film in itself exhibits the hydrophobia necessary for preventing the undesired discharge of water or other liquid via the bottom face of the backing fabric. Furthermore, these films have the additional advantage that, in addition to excellent strength due to their biaxial orientation, these films also exhibit good chemical resistance, such that a corresponding lower roll provided with such a wrapping has a long service and operating life.

In order, in the case of the method according to the invention, to produce the above-described roughness and/or the particles on the surface of the lower roll, a further embodiment of the method according to the invention is characterized in that the corresponding surface, which comes into contact with the bottom face of the backing fabric immediately prior to and during coating, is engraved and especially sandblasted to form the roughness and/or the particles, wherein the desired roughness of the surface of the further web may be set particularly simply, cheaply and without difficulty by the intensity of the sandblasting, the grain size selected therefor and the exposure time.

In order, in the case of the method according to the invention, to prevent particularly effectively the discharge of pasty material, water or another liquid at the underside of the backing fabric during coating and thus to ensure that the top face is uniformly covered and that the bottom face of the backing fabric as far as possible does not come into contact with the overlay material, in a particularly preferred embodiment the backing fabric is fed to the calender in such a way that it partially loops round the lower roll, which is preferably provided with a roughened surface. The looping distance ranges from at least 1% and preferably more than 3% of the circumference of the lower roll, wherein the above-stated looping distance depends in particular on the rate of coating of the backing fabric, the thickness of application of the pasty overlay material and the viscosity of the pasty overlay material. Looping distances which are particularly suitable amount to 5% to 25% of the circumference ofthe lower roll.

In principle, thc above-described embodiments of the method according to the invention provide the possibility of feeding the backing fabric to the calender during coating at any desired angle, wherein, to ensure problem-free coating, contact between the backing fabric and the upper roll should be prevented. It is particularly advantageous for the backing fabric to be fed virtually horizontally directly prior to and during coating, wherein the angle of inclination is to be selected in such a way that rolling back of the paste is prevented. Virtually horizontal backing fabric feed during coating may be achieved, for example, in that the calender, used for coating comprises the largest lower roll possible. Rolls of different diameters are preferred, wherein, as explained above, the upper roll of the calender has a smaller diameter than the lower roll of the calender, preferably amounting to <70% of the diameter of the lower roll. By selecting such a lower calender roll diameter, it is relatively simple to feed the backing fabric to the calender in such a way that the bottom face of the backing fabric lies on the surface of the lower roll, especially on the roughened surface of the lower roll, immediately prior to and during coating, and that in addition the backing fabric is guided horizontally or virtually horizontally immediately prior to and during coating.

In an advantageous development of the method according to the invention, a third roll is associated with the calender, the axis of which roll is preferably positioned downstream of the calender in the backing fabric conveying direction, beneath a plane extending through the nip perpendicularly to the connecting plane of the two roll axes, whereby the backing fabric is guided in such a way that its underside is guided in contact with the lower calender roll. The looping distance and the radius of curvature of the deflection may be optimized by the arrangement and size of the third roll. Depending on the respective material of the overlay paste, paste application may be optimized by changing the looping distance and reducing the radius of curvature.

In order to ensure the above-claimed horizontal feed of the backing fabric immediately prior to and/or during coating with simultaneous looping round the lower roll, a further development of the method according to the invention is characterized in that the connecting plane through the axes of the two calender rolls is inclined in the backing fabric conveying direction. The angle of inclination is preferably 5° to 25°. In other words, in this embodiment of the method according to the invention, the calender used is not one with the axes of rolls arranged vertically one above the other, but rather a calender is used in which the axis of the upper roll is inclined relative to the axis of the lower roll by an angle of between 5° and 25°, preferably when viewed in the backing fabric conveying direction.

As stated repeatedly above with regard to the methods according to the invention, a paste of the material constituting the overlay is applied to one side of the backing fabric in the method according to the invention. In order to adjust the consistency of this paste to the respective backing fabric, which may exhibit different densities due to different backing fabric constructions, a different amount of liquid, for instance water in particulars is added to the material. However, it is particularly suitable, in the case of the method according to the invention, for only water and not an organic solvent to be used as the liquid, wherein a wetting agent is added to the water, in order thereby to adjust the paste to the desired consistency. A non-ionic wetting agent, and preferably a wetting agent based on all alkyl polyglycol ether, is in particular selected therefor, wherein, however, other wetting agents, for example in particular alkylaryl polyglycol ethers, alkylamine polyglycol ethers, alkylamine oxides and/or fatty acid esters of polyalcohols, may also be used.

In order to vary the desired properties of the overlay produced on one side of the backing fabric, another development of the method according to the invention is characterized in that the overlay material paste contains, in addition to polytetrafluoroethylene (PTFE), at least one other polymer, preferably at least one high temperature-resistant polymer.

In the above-described development of the method according to the invention, the high temperature-resistant polymer preferably comprises a polymer selected from the group comprising filly aromatic polyesters, fully aromatic polyamides, polyetherether ketones and/or polyphenylene sulfones.

If it is desired, using the method according to the invention, to produce particularly temperature-resistant overlays with a particularly high load-carrying capacity in one-sided manner on the top face of the backing fabric, another embodiment of the method according to the invention is characterized in that a paste is selected which contains, in addition to polytetrafluoroethylene (PTFE), between 20 vol. % and 60 vol. % of the high temperature-resistant polymer, especially the above-mentioned polymers.

In addition, the method according to the invention provides the possibility of replacing a proportion of the polytetrafluoroethylene, preferably up to 50 vol. % of the polytetrafluoroethylene (PTFE), with other polymers and especially with poly(tetrafluoroethylene-co-perfluorovinyl methyl ether) (PFA), poly(tetrafluoroethylene-co-hexafluoropropylene) (FEP), poly(hexafluoroisobutylene-covinylidene fluoride) (CM-1), poly(ethylene-alt-tetrafluoroethylene) (ETFE) and/or polyvinylidene fluoride (PVDF), as proposed by a further development of the method according to the invention.

A further modification of the overlay arranged in one-sided manner on the top face of the backing fabric may be achieved in that, in a further development of the method according to the invention, an overlay material paste is used in which up to 50 vol. % of the high temperature-resistant polymer is replaced by molybdenum sulfide, tungsten sulfide, boron nitride, graphite, lead, lead oxide, iron oxides, calcium fluoride, glass and/or ceramic powder and/or glass and/or carbon fibers Such a modification of the pasty material applied to the backing fabric allows the properties of the overlay to be adjusted particularly simply and effectively to the respective requirements, wherein it is merely necessary to produce appropriately pasty materials.

In order to finish the bearing material produced using the method according to the invention, a further development of the method according to the invention is characterized in that, after coating of the backing fabric, the coated backing fabric is subjected, optionally after pre-drying, to heat treatment and rolling, in order to fix the overlay permanently on the backing fabric and to achieve the final thickness. A cutting process may then optionally follow, for sizing the backing fabric provided on one side with the overlay, the backing fabric then being coiled for further processing, wherein both coating and heat treatment and also sizing with regard to thickness and width are preferably performed continuously.

The present invention additionally relates to a bearing material produced using one of the above-described embodiments of the method according to the invention, wherein the bearing material according to the invention comprises a backing fabric which is provided on its one surface with an overlay predominantly of polytetrafluoroethylene and as far as possible has no overlay on its other surface (bottom face).

The bearing material according to the invention is used especially as a sliding element in flanged bushes and preferably for vehicle door hinges, wherein special emphasis should be laid in particular on the favorable price of a bearing material produced in this way, in addition to its excellent long-term load-carrying capacity while retaining problem-free functioning.

All the concentrations stated in volume percent in this description relate to the finished overlay.

Advantageous further developments of the method according to the invention are indicated in the subclaims.

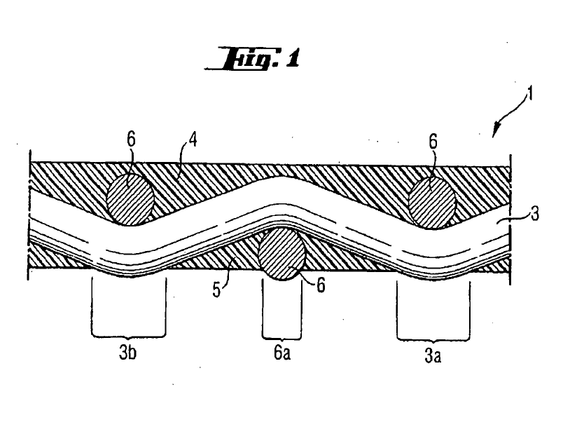

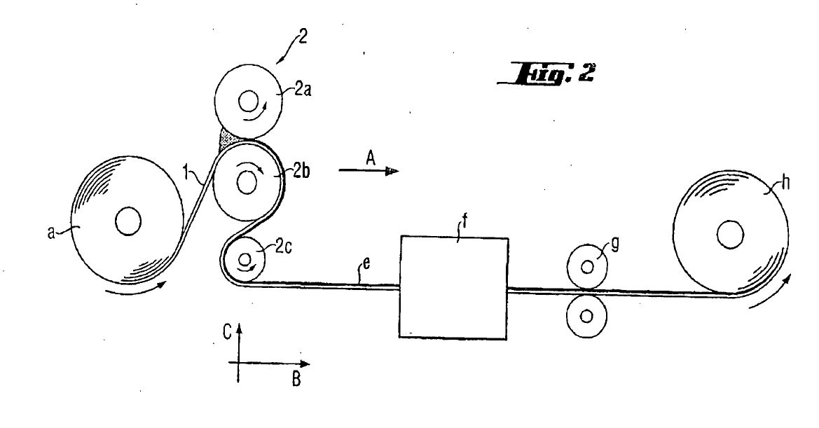

The bearing material according to the invention is explained in more detail below with reference to FIG. 1 and the method according to the invention is explained in more detail below with reference to four exemplary embodiments, illustrated schematically in FIGS. 2 to 5. In the drawings:

FIG. 1 is a schematic sectional view through a backing fabric provided on one side with an overlay;

FIG. 2 is a schematic representation of a first embodiment of the method according to the invention;

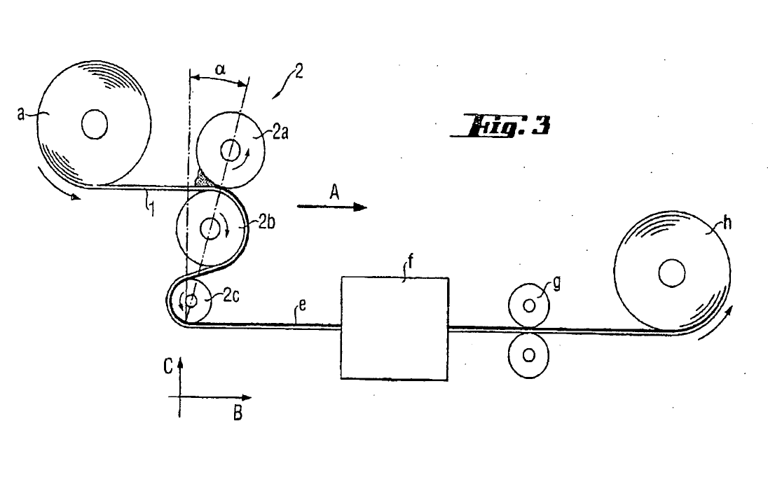

FIG. 3 is a schematic representation of a second embodiment of the method according to the invention; and

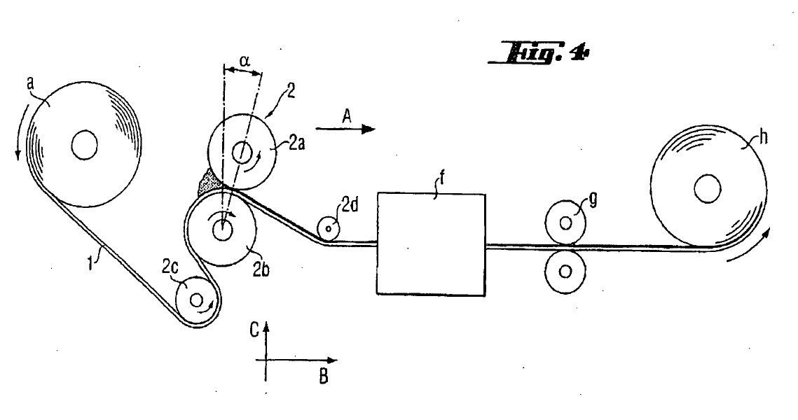

FIG. 4 is a schematic representation of a third embodiment of the method according to the invention;

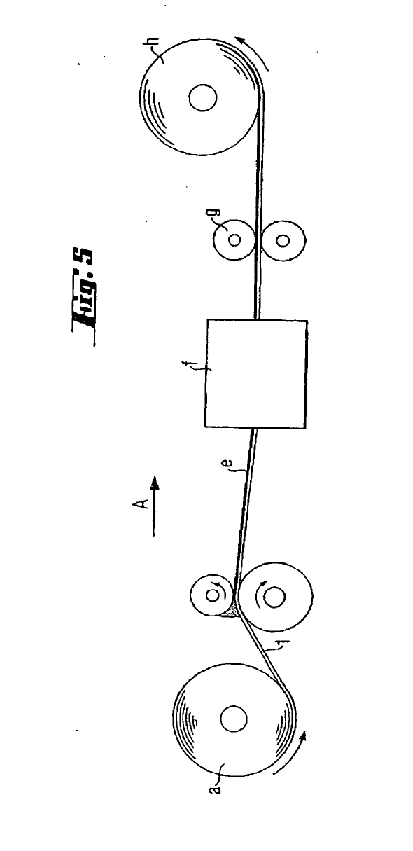

FIG. 5 is a schematic representation of a fourth embodiment of the method according to the invention.

The backing fabric illustrated schematically in FIG. 1 and designated overall as 1 comprises a first thread system 3 and a second thread system 2 extending perpendicularly thereto, wherein the thread systems 2 and 3 consist of metal wires. The backing fabric 1 is provided on its top face with an overlay 4, wherein the overlay 4, which mainly contains polytetrafluoroethylene, covers the backing fabric 1 in one-sided manner as far as its top face is concerned and thus projects thereabove. The opposing bottom face is provided in part with the identical overlay material 5, wherein, however, the overlay 5, unlike the overlay 4, does not cover the bottom face of the backing fabric 1, such that parts of the thread systems 3a, 2a and 3b form the outer bottom face of the backing fabric 1.

In FIGS. 2 to 5 the same elements are provided with the same reference numerals.

All the embodiments illustrated schematically in FIGS. 2 to 5 of the method for producing bearing materials provide a supply roller a for the web of metallic backing fabric 1, wherein the roller a takes the form of an unwinding roller for the backing fabric 1. In the conveying direction of the backing fabric 1, which is identified by the arrow A, a calender 2 is in each case provided whose rolls form a nip through which the backing fabric is guided for coating purposes, wherein in the four embodiments illustrated the calender 2 is of differing constructions, as will be described more fully below In the direction of arrow A, this is followed by a heat treatment device f, through which the backing fabric e coated with the paste is conveyed. Downstream thereof there is provided a further roll pair g, which bring the backing fabric e provided with the overlay to a desired thickness, before the fabric, in the form of a coated backing fabric, is coiled onto a take-up reel h.

The calender illustrated in FIG. 2, in a first embodiment of the method, is designated overall as 2 and comprises an upper roll 2a and a lower, preferably roughened roll 2b forming a nip therewith, wherein the lower roll 2b is associated with a third roll 2c in such a way that, by varying the position of the third roll 2c, for example displacing it in the direction of arrow B or vice versa or by displacing it in the direction of arrow C or vice versa, the looping distance of the backing fabric 1 round the roll 2b may be adjusted as desired.

In order to apply the pasty overlay material to the backing fabric 1 in the embodiment illustrated in FIG. 2, the backing fabric 1 is guided through the nip of the calender 2, which is formed by the rolls 2a and 2b, wherein in particular the amount of overlay material applied may be varied by varying the amount of pasty overlay material supplied, by the linear pressure and by the viscosity of the pasty material.

The second embodiment of the method shown in FIG. 3 does not differ fundamentally from the above-described embodiment with regard to the calender 2. Here too, the calender 2 comprises an upper roll 2a and a lower roll 2b cooperating and forming the nip therewith, wherein the surface of the roll 2b has preferably been roughened. Below the lower roll 2b there is likewise provided a third roll 2c, wherein this roll 2c is preferably mounted so as to be movable in direction B or in direction C or contrary to these two directions, such that the looping distance of the backing fabric around the roll 2b may be varied as desired by appropriate movement and adjusted to the respective requirements.

Unlike in the above-described embodiment, the rolls 2a to 2c are not arranged vertically above one another but rather are inclined at an angle ax of approximately 15° relative to vertical, whereby it may be ensured in a particularly simple manner that the backing fabric 1 is fed substantially horizontally to the nip formed between the rolls 2a and 2b. In this embodiment according to FIG. 3 too, the looping distance of the backing fabric e around the roll 2b after coating may be changed by displacement of the third roll 2c in the direction of arrow B or C and/or contrary thereto.

Like the above-described embodiment, the third embodiment of the method illustrated in FIG. 4 likewise comprises a calender 2 comprising an upper roll 2a, a lower roll 2b and a third roll 2c arranged therebelow. In this embodiment, the rolls 2a and 2b are inclined relative to vertical by an angle α of approximately 15°, as in FIG. 3.

In addition, the third embodiment shown in FIG. 4 comprises a fourth roll 2d arranged downstream of the calender 2 in the backing fabric conveying direction, wherein this roll 2d is likewise mounted so as to be movable preferably in direction B or in direction C or contrary to these two directions, such that the looping distance of the backing fabric around the roll 2b may be changed as desired by appropriate movement and adjusted to the respective requirements. The embodiment illustrated in FIG. 4 differs from the embodiment discussed above and illustrated in FIG. 2 in that, in the embodiment according to FIG. 4, the loop passes firstly round the third roll 2c and only then round the lower roll 2b and in that a fourth roll 2d is provided, such that the looping distance of the backing fabric 1 around the lower roll 2b may be adjusted by changing the position of one or both of the rolls 2c and 2d, i.e. by displacement in direction C and/or in direction B.

The fourth embodiment of the method illustrated in FIG. 5 likewise provides a calender 2, but this calender comprises only an upper roll 2a and a preferably roughened lower roll 2b cooperating therewith. These two rolls 2a and 2b form the nip necessary for coating.

The diameter of the upper roll 2a amounts at most to 70% of the dianieter of the lower roll 2b and the nip is positioned relative to the winding axis of the supply roller a and to the entry slit of the heat treatment device f in such a way that immediately before, during and after coating the backing fabric 1 lies on the appropriately roughened surface of the lower roll 2b, in order to achieve the desired one-sided coating of the backing fabric mainly on the top face, as shown in FIG. 1.

The rolls 2a and 2b described above in relation to the first to third exemplary embodiments and illustrated in FIGS. 2 to 4 together with the roll 2a illustrated in FIG. 5 preferably exhibit diameters of between 90 mm and 300 mm, wherein the respective lower roll 2b always has a roughened surface.

1. A method of producing bearing materials, in which a web of a metallic backing fabric is provided continuously with an overlay covering the backing fabric on one side and mainly containing polytetrafluoroethylene (PTFE), characterized in that the backing fabric is coated on its top face with a paste of the overlay material and in that the backing fabric is guided during and immediately after coating with its bottom face hi all-over contact with a roll.

2. A method according to claim 1, characterized in that, for coating purposes, the web of hacking fabric is guided through the nip of a calender comprising an upper roll and a lower roll, in such a way that the bottom face of the backing fabric lies on the surface of the lower roll.

3. A method according to claim 2, characterized in that the web of backing fabric is guided through the nip of a calender whose upper roll has a smaller diameter than the lower roll and/or whose lower roll is roughened.

4. A method according to claim 3, characterized in that the web of backing fabric is guided through the nip of a calender whose upper roll has a diameter <70% of the diameter of the lower roll.

5. A method according to one of claims 1 to 4, characterized in that a roll is selected as lower roll whose surface facing the bottom face of the backing fabric is provided with uniformly distributed particles and/or unevennesses of the order of between 5 μm and 50 μm, preferably between 10 μm and 30 μm.

6. A method according to one of the preceding claims, characterized in that the surface of the lower roll is provided with a wrapping of paper, plastics and/or textiles.

7. A method according to claim 6, characterized in that a film of biaxially oriented polyester or biaxially oriented polycarbonate is selected as the wrapping.

8. A method according to claim 5, characterized in that the surface of the lower roll is sandblasted or engraved to form the particles.

9. A method according to one of the preceding claims, characterized in that the backing fabric is fed to the calender in such a way that it loops in part round the lower roll, wherein the looping distance amounts to at least 1%, preferably more than 3%, of the circLIumferenice of the loweer roll.

10. A method according to one of the preceding claims, characterized in that the backing fabric is guided horizontally during coating.

11. A method according to claim 9 or claim 10, characterized in that a third roll is associated with the calender, which is positioned downstream of the nip when viewed in the backing fabric conveying direction, and in that the backing fabric is guided with its top face in contact with the third roll.

12. A method according to claim 8 or claim 9, characterized in that the upper roll of the calender is inclined relative to vertical by an angle of 50 to 25°.

13. A method according to one of the preceding claims, characterized in that the consistency of the paste is adjusted solely by the addition of a wetting agent.

14. A method according to claim 13, characterized in that a non-ionic wetting agent, preferably a wetting agent based on an alkyl polyglycol ether, is selected as wetting agent.

15. A method according to one of the preceding claims, characterized in that the overlay material paste contains, in addition to polytetrafluoroethylene (PTFE), also at least one high temperature-resistant polymer.

16. A method according to claim 15, characterized in that the at least one high temperature-resistant polymer is selected from the group comprising fully aromatic polyesters, fully aromatic polyamides, polyetherether ketones and/or polyphenylene sulfones.

17. A method according to claim 15 or claim 16, characterized in that a paste is selected which comprises, in addition to polytetrafluoroethylene (PTFE), between 20 and 60 vol. % of the high temperattire-resistant polymer.

18. A method according to one of claims 15 to 17, characterized in that up to 50 vol. % of the polytetrafluoroetliylene (PTFE) is replaced by poly(tetrafluoroethylene-co-perfluorovinyl methyl ether) (PFA), poly(tetrafluoroethylene-co-hexafluoropropylene) (FEP), poly(hexafluoroisobutylene-covinylidene fluoride) (CM-1), poly(ethylene-alt-tetrafluoroethylene) (ETFE) and/or polyvinylidene fluoride (PVDF).

19. A method according to one of the preceding claims, characterized in that an overlay material paste is selected in which up to 50 vol. % of the high temperature-resistant polymer is replaced by molybdenum sulfide, tungsten sulfide, boron nitride, graphite, lead, lead oxide, iron oxides, calcium fluoride, glass and/or ceramic powder and/or glass and/or carbon fibers.

20. A method according to one of the preceding claims, characterized in that the coated backing fabric is subjected to a heat treatment after coating thereof.

21. A bearing material produced according to one of claims 1 to 20, having a backing fabric, wherein the backing fabric has on its top face an overlay predominantly of polytetrafluoroethylene (PTFE) and as far as possible has no overlay oil its other surface.

22. Use of the bearing material produced according to one of claims 1 to 20 as a sliding clement in flanged hushes, especially for vehicle door hinges.
